(19) United States
(12) Patent Application Publication
(10) Pub. No.: US 2023/0234891 A1
(43) Pub. Date: Jul. 27, 2023

(54) BINDER FOR INJECTION MOULDING COMPOSITION

(71) Applicants: SAINT-GOBAIN CENTRE DE RECHERCHES ET D'ETUDES EUROPEEN, COURBEVOIE (FR); CENTRE NATIONAL DE LA RECHERCHE SCIENTIFIQUE, PARIS CEDEX 16 (FR); UNIVERSITE CLAUDE BERNARD LYON I, VILLEURBANNE (FR); UNIVERSITE JEAN MONNET SAINT-ETIENNE, SAINT-ETIENNE CEDEX 2 (FR)

(72) Inventors: Thomas PERIE, AIX EN PROVENCE (FR); Eric LINTINGRE, AVIGNON (FR); Marie Camille AUSCHER, SCHREWSBURY, MA (US); Zoé BUNIAZET, CHARLEVAL (FR); Claire DELAROA, VILLEURBANNE (FR); Philippe CASSAGNAU, MILLERY (FR); René FULCHIRON, SAINT-DIDIER-AU-MONT-D'OR (FR)

(21) Appl. No.: 18/007,637

(22) PCT Filed: Jun. 2, 2021
(86) PCT No.: PCT/FR2021/051003

§ 371 Date: Dec. 1, 2022

(30) Foreign Application Priority Data
Jun. 5, 2020 (FR) 2005887

(51) Int. Cl. C04B 35/634; C04B 35/638; C04B 35/64

(52) U.S. Cl. CPC C04B 35/63496; C04B 35/6344; C04B 35/63408; C04B 35/638; C04B 35/64; C04B 2235/6022

(57) ABSTRACT

A binder for an injection moulding composition, the binder includes, in percentage by mass and for a total of 100%: 35% to 60% of a component (a), or polymer base, made of a polymer or a mixture of polymers, each of the polymer being non-amphiphilic and having a mass average molar mass greater than or equal to 5,000 g/mol, 30% to 55% of a component (b), or wax, made of a polymer or a mixture of polymers, each of the polymer being non-amphiphilic and having a mass average molar mass less than 5,000 g/mol, and less than 10% of an amphiphilic component (c), or surfactant, and less than 10% of other components (d). The polymer base comprising 2% to 15% of a styrene-ethylene-butylene-styrene copolymer (SEBS), in percentage by mass based on the mass of the binder.

### TECHNICAL FIELD

The present invention relates to a binder for an injection molding composition and to an injection molding composition comprising said binder.

### PRIOR ART

Powder injection molding makes it possible to obtain a wide variety of shapes of parts in a wide variety of materials, in particular plastics, metals and ceramics. This method also makes it possible to manufacture large quantities of parts, while reducing production times.

A method for manufacturing a sintered part which implements powder injection molding conventionally comprises the following steps:

A) producing the molding composition,
B) injection molding said molding composition in order to obtain a preform,
C) at least partially debinding the preform,
D) sintering the at least partially debound preform in order to obtain a sintered part.

Step A) consists in mixing an organic binder and a powder, for example a metal or ceramic powder, optionally functionalized with the aim of improving contact with the binder.

The binder conventionally comprises a polymer base, a wax and a surfactant. The role of the binder is to facilitate the flow of the molding composition during the injection molding in step B), and to afford sufficient mechanical strength to the preform in order to enable handling thereof.

Ceramic powders and metal powders have different properties, particularly different grain surface properties and flow properties. The problems raised by the injection molding of molding compositions comprising metal powders and ceramic powders, and the technical solutions adopted to solve said problems, are generally different. In particular, a binder developed for a molding composition based on a metal powder cannot a priori be used as is for a molding composition based on a ceramic powder.

At the end of step A), a molding composition, conventionally referred to as “feedstock”, is obtained.

Step A) also conventionally comprises a granulation, so that the molding composition is in the form of granules.

In step B), after being heated, the molding composition is injection molded, conventionally using an injection molding machine, so as to obtain a preform.

Step C) consists in eliminating, at least partially, preferably entirely, the binder present in the preform, conventionally by subjecting said preform to an attack by a solvent (“solvent” debinding) then a thermal attack (thermal debinding).

The debinding may deform the preform, leading to the manufacture of an unacceptable sintered part.

Step D) consists in consolidating the preform by sintering so as to obtain the desired part, and also in eliminating any potential binder which was not eliminated during step C). In one embodiment, the thermal debinding of step C) and the sintering of step D) are performed within the same step, during a single heat cycle.

There is a persistent need fora method which limits the deformation of the preform in step C) while leading to a sintered part having a relatively high density.

One aim of the invention is to at least partially meet this need.

### DISCLOSURE OF THE INVENTION

### Summary of the Invention

The invention relates to a binder for an injection molding composition, said binder consisting of, in percentage by weight:
35% to 60% of a component (a), or “polymer base”, consisting of a polymer or a mixture of polymers, each said polymer
being devoid either of hydrophilic group(s) or of hydrophobic group(s) or of hydrophilic group(s) and hydrophobic group(s), that is being “non-amphiphilic”, and
having a weight-average molar mass of greater than or equal to 5,000 g/mol,
30% to 55% of a component (b), or “wax”, consisting of a polymer or a mixture of polymers, each said polymer
being non-amphiphilic and
having a weight-average molar mass of less than 5,000 g/mol, and
less than 10% of an amphiphilic component (c), or “surfactant”, and
less than 10% of other components (d),
   the total sum of the percentages of components (a), (b), (c) and (d) being equal to 100%,
   the polymer base comprising 2% to 15% of a styrene-ethylene-butylene-styrene copolymer or “SEBS”, in percentage by weight based on the weight of the binder, the content by weight of styrene in the SEBS being greater than 15% in percentage by weight based on the weight of said SEBS, the weight-average molar mass of said SEBS being greater than 100,000 g/mol.

Remarkably, the inventors have observed that the presence of such a polymer base at the indicated contents limits the deformation of the preform in step C) while leading to a sintered part having a relatively high density.

A binder according to the invention advantageously makes it possible to limit operations of reworking by machining, which are expensive or even impossible in the case of complex shapes.

A binder for an injection molding composition according to the invention may further have one or more of the following optional characteristics:
the SEBS content is greater than or equal to 4% and less than or equal to 13%;
the content by weight of styrene in the SEBS is greater than 20%, preferably greater than 25%, and less than 60% in percentage by weight based on the weight of said SEBS;
the weight-average molar mass of the SEBS is greater than 160,000 g/mol and less than 400,000 g/mol;
the amount of surfactant is greater than or equal to 0.5%;
the binder has, in percentage by weight based on the binder:
   an amount of polymer base of greater than or equal to 40%, preferably greater than or equal to 45% and less than or equal to 55%, preferably less than or equal to 50%, and
   an amount of wax of greater than or equal to 35%, preferably greater than or equal to 40% and less than or equal to 53%, preferably less than or equal to 50%, and
   an amount of surfactant: greater than or equal to 1%, preferably greater than or equal to 2% and less than or equal to 8%, preferably less than or equal to 6%, and/or
   an amount of other components, preferably a stabilizer, of greater than or equal to 0.5%, preferably greater than or equal to 1% and less than or equal to 8%, preferably less than or equal to 4%;
   each constituent of the polymer base has a weight-average molar mass of greater than 20,000 g/mol, preferably greater than 30,000 g/mol, and/or
      a constituent of the wax, preferably each constituent of the wax, has a weight-average molar mass of greater than 400 g/mol and less than 3,000 g/mol, preferably less than 1,500 g/mol, and/or
      each constituent of the surfactant has a weight-average molar mass of less than 800 g/mol, preferably less than 500 g/mol;
the polymer base of the binder comprises a polymer selected from polypropylenes, polyethylenes, ethylene-vinyl acetates, ethylene-ethyl acrylates, polystyrenes, polyethylene carbonates, diethyl phthalate, dioctyl phthalate, dibutyl phthalate, polyvinyl alcohol, polyvinyl acetate, ethylene-methacrylic acid copolymers, polyvinyl chloride, polyvinyl butyral, a polyacetal, a polymethyl methacrylate, a polybutyl methacrylate, a methacrylic acid ester copolymer, a methyl ethyl ketone, resins, and mixtures thereof, and/or
   the wax of the binder comprises, or even consists of, a wax selected from carnauba wax, a paraffin wax, a beeswax, a polyethylene wax, a microcrystalline wax, a vegetable oil, a groundnut oil, a mineral oil, glycerol and mixtures thereof, preferably a paraffin wax, and/or
   the surfactant of the binder comprises, or even consists of, an amphiphilic constituent selected from an ethylene bis(stearamide), stearin, palmitic acid, butyl stearate, boric acid, oleic acid, lauric acid, stearic acid and mixtures thereof;
the polymer base of the binder comprises a mixture of polypropylene and of polyethylene in a polypropylene/polyethylene weight ratio of greater than 25/75 and less than 50/50, and/or
   the surfactant of the binder consists of an amphiphilic constituent selected from an ethylene bis(stearamide), stearic acid and mixtures thereof.

The invention also relates to an injection molding composition comprising a binder according to the invention at an amount of between 30% and 65% in percentages by volume based on the volume of the molding composition, the remainder being, for more than 90% by weight, a ceramic powder.

An injection molding composition according to the invention may further have one or more of the following optional characteristics:
the amount of binder is greater than or equal to 45% and less than or equal to 55%, in percentage by volume based on the volume of the molding composition, and/or the ceramic powder comprises more than 90% by weight of nitride(s) and/or carbide(s) and/or oxide(s);
the ceramic powder comprises more than 90% by weight of oxide(s), said oxides being selected from ZrO₂, Y₂O₃, CeO₂, CaO, MgO, manganese oxides, ZnO, praseodymium oxides, copper oxides, BaO, iron oxides, Sc₂O₃, TiO₂, Al₂O₃, La₂O₃, Nd₂O₃, Yb₂O₃, and mixtures thereof.

The invention further relates to a method for manufacturing a sintered part, said method comprising steps A) to D) described above, the molding composition being in accordance with the invention.

### Definitions

“Polymer” is conventionally used to refer to a macromolecule consisting of a chain of identical or different monomers, linked to one another by covalent bonds.
The “weight-average molar mass” of a component, denoted M_{w}, is conventionally used to refer to the average of the molar masses of all the chains of the component in a sample, weighted by the mass of the chains of each length in said sample. Mi is the molar mass of a chain i and Ni is the number of chains of mass Mi; the weight-average molar mass is equal to:

$$M w = \frac{{Σ}_{i} Ni \cdot {Mi}^{2}}{{Σ}_{i} Ni \cdot Mi}$$

“High density polyethylene” or HDPE is conventionally used to refer to a polyethylene having a density of greater than or equal to 930 kg/m³ and less than or equal to 970 kg/m³.
A component is said to be “amphiphilic” when it has both a portion composed of one or more hydrophilic group(s) and a portion composed of one or more hydrophobic group(s). On the contrary, a component referred to as “non-amphiphilic”is devoid either of hydrophilic group(s), or of hydrophobic group(s), or of hydrophilic and hydrophobic group(s).
A component, particularly a polymer or a powder, are said to be “functionalized” when one or more chemical groups which afford them one or more specific properties have been modified, particularly by addition and/or replacement. For example, the particles of a silica powder can be functionalized by the action of silanes, leading to the surface of said particles becoming hydrophobic.
A “ceramic powder” is a powder consisting of more than 95%, preferably more than 98%, preferably more than 99% by weight, of particles, each consisting, for more than 95%, preferably more than 98%, preferably more than 99% of the weight thereof, of a ceramic material. Said particles may or may not have the same composition.
“Sintering” is conventionally used to refer to the consolidation, by a heat treatment, conventionally at more than 1,100° C., of a preform comprising an agglomerate of particles. The sintering may be in the liquid phase when the heat treatment leads to the appearance of a liquid which will make it possible for the grains to be rearranged and form liquid bridges therebetween, in order to bring them into contact with one another. The sintering can also be in the solid phase when, during the heat treatment, the welding between the grains is carried out without creating a liquid phase.
The “median size” of a powder of particles, generally denoted D50, is the size which divides the particles of this powder into first and second populations which are equal in weight, with these first and second populations only comprising particles having a size greater than, or less than, respectively, the median size. The median size may for example be evaluated using a laser particle size analyzer.
The “relative density” of a product is used to refer to the ratio of the apparent density divided by the absolute density, expressed in percentage.
The “apparent density” of a product is conventionally used to refer to the ratio of the mass of said product divided by the volume said product occupies. It can be measured by imbibition using the principle of buoyancy.
The “absolute density” of a product is conventionally used to refer to the theoretical mass of said product, without taking into account any porosity. It can be calculated from crystallographic data or for example also obtained by the ratio of the mass of solids of said product, measured after grinding to a level of fineness such that substantially no closed pores remain, divided by the volume of this mass after grinding. It can therefore be measured using helium pycnometry.

All the percentages in the present description are percentages by weight, unless indicated otherwise.

All the characteristics of the binder and of the molding composition can be measured in accordance with the protocols described for the examples.

The verbs “contain”, “comprise” and “have” should be interpreted broadly and non-limitingly, unless indicated otherwise.

### BRIEF DESCRIPTION OF THE DRAWINGS

Other characteristics and advantages of the invention will become clearer upon reading the following detailed description and upon examining the appended drawing, wherein

FIGS. 1 and 2 depict the mounting of a bar of molding composition to measure the deformation after debinding using a solvent or thermal debinding, and the same mounting after debinding.

### DETAILED DESCRIPTION

### Binder for Injection Molding Composition

A binder for an injection molding composition according to the invention can be manufactured by a conventional manufacturing method, by simply mixing the components (a), (b), optionally (c) and optionally (d), for example at ambient temperature.

This mixing may also be carried out while the molding composition is being produced.

Component (a) is the polymer base and represents 35% to 60% of the weight of the binder.

Preferably, the amount of polymer base is greater than or equal to 40%, preferably greater than or equal to 45% and/or less than or equal to 55%, preferably less than or equal to 50% of the weight of the binder.

The polymer base consists of an amphiphilic polymer or a mixture of non-amphiphilic polymers which, unlike the polymer or mixture of polymers of the wax, each have a weight-average molar mass of greater than or equal to 5,000 g/mol.

Each constituent of the polymer base preferably has a weight-average molar mass of greater than 8,000 g/mol, preferably greater than 10,000 g/mol, preferably greater than 20,000 g/mol, preferably greater than 30,000 g/mol.

In particular, the polymer base preferably comprises a polymer, which preferably constitutes the remainder to the SEBS in the polymer base, selected from polypropylenes, polyethylenes, ethylene-vinyl acetates, ethylene-ethyl acrylates, polystyrenes, polyethylene carbonates, diethyl phthalate, dioctyl phthalate, dibutyl phthalate, polyvinyl alcohol, polyvinyl acetate, ethylene-methacrylic acid copolymers, polyvinyl chloride, polyvinyl butyral, a polyacetal, a polymethyl methacrylate, a polybutyl methacrylate, a methacrylic acid ester copolymer, a methyl ethyl ketone, resins, preferably acrylic resins, ketone resins and mixtures thereof, and mixtures thereof.

Preferably, the polymers of the polymer base which constitute the remainder to the SEBS in the polymer base are selected from polypropylenes, polyethylenes, ethylene-vinyl acetates, ethylene-ethyl acrylates, polystyrenes, polyethylene carbonates, polyvinyl chloride, acrylic resins and mixtures thereof.

Preferably, as the remainder to the SEBS, the polymer base comprises, preferably consists of, a mixture of polypropylene and of polyethylene, preferably in a polypropylene/polyethylene weight ratio of greater than 25/75, preferably greater than 30/70, and less than 50/50. The polyethylene is preferably a high-density polyethylene.

According to the invention, the polymer base comprises 2% to 15% of a SEBS in percentage by weight based on the weight of the binder. Preferably, the content of SEBS is greater than or equal to 3%, preferably greater than or equal to 4% and/or less than or equal to 13%, preferably less than or equal to 11%, or even less than or equal to 9%, or even less than or equal to 7%.

According to the invention, the content by weight of styrene in the SEBS is greater than 15% in percentage by weight based on the weight of said SEBS. Preferably, the content of styrene in the SEBS is greater than 20%, preferably greater than 25%, and/or preferably less than 60%, preferably less than 58%, in percentage by weight based on the weight of said SEBS.

Also according to the invention, the weight-average molar mass of the SEBS is greater than 100,000 g/mol. Preferably, the weight-average molar mass of the SEBS is greater than 130,000 g/mol, preferably greater than 160,000 g/mol, preferably greater than 200,000 g/mol, and/or preferably less than 400,000 g/mol, preferably less than 350,000 g/mol.

Component (b) is the wax and represents 30% to 55% of the weight of the binder.

Preferably, the amount of wax is greater than or equal to 35%, preferably greater than or equal to 40%, preferably greater than or equal to 45% and/or less than or equal to 53%, preferably less than or equal to 50% of the weight of the binder.

A constituent of the wax, preferably each constituent of the wax, preferably has a weight-average molar mass of less than 4,000 g/mol, preferably less than 3,000 g/mol, preferably less than 2,000 g/mol, preferably less than 1,500 g/mol and/or greater than 400 g/mol, preferably greater than 500 g/mol.

In particular, the wax can comprise, or even consist of, a polymer selected from carnauba wax, a paraffin wax, a beeswax, a polyethylene wax, a microcrystalline wax, a vegetable oil, a groundnut oil, a mineral oil, glycerol and mixtures thereof, preferably a paraffin wax.

Preferably, the wax consists of a non-amphiphilic polyolefin or a mixture of non-amphiphilic polyolefins which each have a weight-average molar mass of less than 5,000 g/mol, preferably less than 4,000 g/mol, preferably less than 3,000 g/mol, preferably less than 2,000 g/mol, preferably less than 1,500 g/mol and/or greater than 400 g/mol, preferably greater than 500 g/mol.

The constituents of the wax, particularly the polyolefins, may or may not be functionalized.

The melting point of the wax is preferably greater than 40° C., preferably greater than 45° C. and/or preferably less than 110° C., preferably less than 100° C., preferably less than 90° C.

Component (c) is the surfactant and represents less than 10% of the weight of the binder.

Preferably, the amount of surfactant is greater than or equal to 0.5%, preferably greater than or equal to 1%, preferably greater than or equal to 2% and/or less than or equal to 9%, preferably less than or equal to 8%, preferably less than or equal to 6%, preferably less than or equal to 5%, preferably less than or equal to 4% of the weight of the binder.

The surfactant consists of an amphiphilic constituent or a mixture of amphiphilic constituents. Each amphiphilic constituent of the surfactant preferably has a weight-average molar mass of less than 1,000 g/mol, preferably less than 800 g/mol, preferably less than 500 g/mol.

In particular, the surfactant comprises, or even consists of, an amphiphilic constituent selected from an ethylene bis(stearamide), stearin, palmitic acid, butyl stearate, boric acid, oleic acid, lauric acid, stearic acid and mixtures thereof, preferably from an ethylene bis(stearamide), stearic acid and mixtures thereof.

In one embodiment, the surfactant comprises stearic acid and/or an ethylene bis(stearamide), preferably in a stearic acid/ethylene (bis)stearamide weight ratio of greater than 0.8, preferably greater than 0.9 and less than 1.2, preferably less than 1.1.

In a preferred embodiment, the surfactant consists of an amphiphilic constituent selected from an ethylene bis(stearamide), stearic acid and mixtures thereof; preferably, the surfactant is stearic acid.

The other components (d) are all the optional components which are not components (a), (b) or (c). They represent less than 10%.

Preferably, more than 80%, preferably more than 90%, preferably more than 92%, preferably more than 95%, preferably more than 97%, preferably more than 99%, preferably more than 99.5%, preferably more than 99.9% by weight of the other components (d) are organic components.

Preferably, the amount of the other components (d) is less than or equal to 8%, preferably less than or equal to 6%, preferably less than or equal to 5% preferably less than or equal to 4%, preferably less than or equal to 3% of the weight of the binder.

In one embodiment, the amount of the other components (d) is greater than or equal to 0.5%, preferably greater than or equal to 1% and less than or equal to 8%, preferably less than or equal to 6%, preferably less than or equal to 5%, preferably less than or equal to 4%, preferably less than or equal to 3% of the weight of the binder.

Preferably, in this embodiment, the other components are selected from compounds which make it possible to slow down, delay or even eliminate the degradation of the components (a) and/or (b) and/or (c) of the binder under the action of heat, light, moisture and/or oxygen. These components are conventionally referred to as stabilizers. A stabilizer making it possible to slow down, delay or even eliminate the degradation of the components (a) and/or (b) and/or (c) of the binder under the action of heat, under the action of light, under the action of oxygen, is conventionally referred to as a heat stabilizer, light stabilizer, or antioxidant, respectively. Said stabilizers are preferably selected from aluminum, zinc, lead, sodium, cadmium, magnesium, calcium, barium stearates and mixtures thereof, barium, cadmium, tin laurates and mixtures thereof, magnesium or sodium maleates and mixtures thereof, magnesium or sodium phthalates and mixtures thereof, magnesium or sodium naphthenates and mixtures thereof, epoxidized soybean or castor oil and mixtures thereof, aliphatic amines, hindered phenolic compounds, organic phosphites, mercaptans, butylated hydroxytoluenes, butylated hydroxyanisoles, pentaerythritol tetrakis(3,5-di-tert-butyl-4-hydroxyhydrocinnamate), and mixtures thereof. The stabilizer is preferably pentaerythritol tetrakis(3,5-di-tert-butyl hydroxyhydrocinnamate). The presence of processing stabilizers, in particular components acting as an antioxidant, advantageously makes it possible to increase the shelf life of the binder.

In a preferred embodiment, the binder according to the invention has, in percentage by weight based on the binder:
an amount of polymer base of greater than or equal to 40%, preferably greater than or equal to 45% and less than or equal to 55%, preferably less than or equal to 50%, and
an amount of wax of greater than or equal to 35%, preferably greater than or equal to 40%, preferably greater than or equal to 45% and less than or equal to 53%, preferably less than or equal to 50%, and
an amount of surfactant of greater than or equal to 0.5%, preferably greater than or equal to 1%, preferably greater than or equal to 2% and less than or equal to 9%, preferably less than or equal to 8%, preferably less than or equal to 6%, preferably less than or equal to 5%, preferably less than or equal to 4%, and
an amount of other components, preferably a stabilizer, of greater than or equal to 0.5%, preferably greater than or equal to 1% and less than or equal to 8%, preferably less than or equal to 6%, preferably less than or equal to 5%, preferably less than or equal to 4%, preferably less than or equal to 3%.

### Injection Molding Composition

An injection molding composition according to the invention can be manufactured by a conventional manufacturing method, as long as the binder is a binder according to the invention.

The amount of binder is between 30% and 65%, in percentage by volume based on the volume of the molding composition.

Preferably, the amount of binder is greater than or equal to 35%, preferably greater than or equal to 40%, preferably greater than or equal to 45% and/or less than or equal to 60%, preferably less than or equal to 55%, in percentage by volume based on the volume of the molding composition. Advantageously, the homogeneity of the sintered part obtained at the end of step D) is improved thereby and the injection molding carried out in step B) is facilitated thereby.

The remainder to 100% preferably consists, for more than 90%, preferably for more than 95%, preferably for more than 98%, preferably for more than 99%, preferably for more than 99.9% by weight, of a ceramic powder.

The ceramic powder preferably comprises more than 90%, preferably more than 95%, preferably more than 98%, preferably more than 99% by weight of nitride(s) and/or of carbide(s) and/or of oxide(s).

Preferably, the nitride(s) are selected from AlN, Si₃N₄, Si₂ON₂, BN, TiN, GaN and mixtures thereof.

Preferably, the carbide(s) are selected from TiC, TaC, SiC, WC, ZrC, B₄C and mixtures thereof.

Preferably, the oxide(s) are selected from ZrO₂, Y₂O₃, CeO₂, CaO, MgO, Sc₂O₃, TiO₂, Al₂O₃, La₂O₃, Nd₂O₃, Yb₂O₃ and mixtures thereof.

Preferably, the ceramic powder is a powder comprising more than 90%, preferably more than 95%, preferably more than 98%, preferably more than 99% by weight of oxides, said oxides preferably being selected from ZrO₂, Y₂O₃, CeO₂, CaO, MgO, manganese oxides, ZnO, praseodymium oxides, copper oxides, BaO, iron oxides, Sc₂O₃, TiO₂, Al₂O₃, La₂O₃, Nd₂O₃, Yb₂O₃ and mixtures thereof, preferably selected from ZrO₂, Y₂O₃, CeO₂, Al₂O₃ and mixtures thereof.

In a first embodiment, the ceramic powder has the following chemical analysis, in percentages by weight based on the oxides:
ZrO₂ partially stabilized with CeO₂ and Y₂O₃: remainder to 100%,
Al₂O₃: 3-22%
CaO+manganese oxides expressed in the form MnO+ZnO+La₂O₃+praseodymium oxides expressed in the form Pr₆O₁₁+SrO+copper oxides expressed in the form CuO+Nd₂O₃+BaO+iron oxides expressed in the form Fe₂O₃: 0.2-6%,
Oxides other than ZrO₂, Al₂O₃, Y₂O₃, CeO₂, CaO, manganese oxides, ZnO, La₂O₃, praseodymium oxides, SrO, copper oxides, Nd₂O₃, BaO, iron oxides: <2%,
   CeO₂ and Y₂O₃ being present in amounts such that, in molar percentages based on the sum of ZrO₂, CeO₂ and Y₂O₃,

### CeO₂: 2.5-6.5 mol % and

Y₂O₃: 0.5-2 mol %,
with the proviso that, if Al₂O₃<10%, the following formula (1) must be complied with:

CeO₂>−0.57.Al₂O₃+8.2, (1)

CeO₂ being expressed in molar percentage based on the sum of ZrO₂, CeO₂ and Y₂O₃, and Al₂O₃ being expressed in percentage by weight based on the weight of the product,

In a second embodiment, the ceramic powder has the following chemical analysis, in percentages by weight based on the oxides:
ZrO₂ partially stabilized with CeO₂ and Y₂O₃: remainder to 100%,
Al₂O₃: 10-60%
CaO+manganese oxides expressed in the form MnO+ZnO+La₂O₃+praseodymium oxides expressed in the form Pr₆O₁₁+SrO+copper oxides expressed in the form CuO+Nd₂O₃+BaO+iron oxides expressed in the form Fe₂O₃: 0.2-6%,
CaO≤2%
Oxides other than ZrO₂, Al₂O₃, Y₂O₃, CeO₂, CaO, manganese oxides, ZnO, La₂O₃, praseodymium oxides, SrO, copper oxides, Nd₂O₃, BaO, iron oxides: <2%,
   CeO₂ and Y₂O₃ being present in amounts such that, in molar percentages based on the sum of ZrO₂, CeO₂ and Y₂O₃,

### CeO₂: 6-11 mol % and

Y₂O₃: 0.5-2 mol %.

The ceramic powder preferably has a median size of less than 2 μm, preferably less than 1 μm, preferably less than 0.8 μm, preferably less than 0.6 μm, preferably less than 0.5 μm, preferably less than 0.4 μm.

More preferably still, the ceramic powder has a moisture content of less than 1.5%, preferably less than 1%, preferably less than 0.5%.

### EXAMPLES

The following non-limiting examples are given with the aim of illustrating the invention.

### Measurement Protocols

The weight-average molar mass of the components is determined by size exclusion chromatography according to standard ISO16014-4, on a Viscotek HT-GPC apparatus sold by Malvern Panalytical, equipped with a PSS-Polefin combination medium column, sold by PSS-Polymer.

During the measurements, the column and the Viscotek HT-GPC detector are at a temperature equal to 150° C.

For each component for which the molar mass is to be determined, a solution is prepared in the following manner: said component is introduced into 1,2,4-trichlorobenzene (solvent) so as to obtain a concentration of said component equal to 5 mg/cm3. During this step, the solvent is kept at a temperature equal to 150° C., and the component is introduced into the solvent without stirring, with a dissolution time equal to 1 hour. 2,6-di-tert-butyl-4-methylphenol is subsequently added at an amount equal to 200 mg/l of solution, to prevent degradation of the component. The temperature of the solution is kept at 150° C. until the measurement.

Each solution is injected at a flow rate equal to 1 ml/min.

For all the components with the exception of the SEBS, the column is calibrated using PSS-pekit polyethylene standards, sold by PSS-Polymer. For the SEBS, the column is calibrated using High Temperature PSS-pskitr10ht polystyrene standards, sold by PSS-Polymer.

The Omnisec Software sold by Malvern Panalytical is used for processing the data and measuring the weight-average molar mass.

For each component, the weight-average molar mass is the arithmetic mean of three measurements.

The styrene content of the SEBS is determined by proton nuclear magnetic resonance (NMR) spectroscopy according to the following method. SEBS is introduced into chloroform at ambient temperature at an amount equal to 60 mg/ml chloroform. The mixture is subsequently stirred for 5 minutes using a vibrating stirrer plate. The mixture is subsequently analyzed by proton NMR at a rotational frequency equal to 500 Hz, over an average of 124 measurement points. The NMR spectrum obtained makes it possible to determine the content by weight of styrene, expressed as percentage by weight based on the weight of the SEBS.

The following measurement methods enable an excellent simulation of the actual behavior during the manufacture of the sintered part.

Deformation after debinding using a solvent is measured as follows:

A binder and a powder, CZ3Y, sold by Saint-Gobain Zirpro are introduced into a Haake Rheomix mixer sold byThermo Fisher Scientific. The amount of binder and the amount of CY3Z powder are equal to 50% by volume based on the sum of the volume of binder and CY3Z powder, respectively. The binder and the CY3Z powder are subsequently mixed for 45 minutes, at a rate equal to 30 rpm, the temperature in the mixer being brought to 180° C., the mixture being kept at this temperature for 10 minutes so as to obtain the injection molding composition. After cooling, the hardened injection molding composition is ground so as to pass through the square holes in a screen having 2 mm opening in order for it to be in the form of granules. The injection molding composition thus obtained is subsequently injected, using a babyplast injection molding machine, sold by Martiplast, at a pressure equal to 100 bar, at a temperature, measured in the injection screw, equal to 170° C., in a bar mold at a temperature equal to 40° C. and shaped so as to obtain a bar having dimensions equal to 75 mm×13 mm×2 mm after removal from the mold. 5 bars are produced for each molding composition to be characterized.

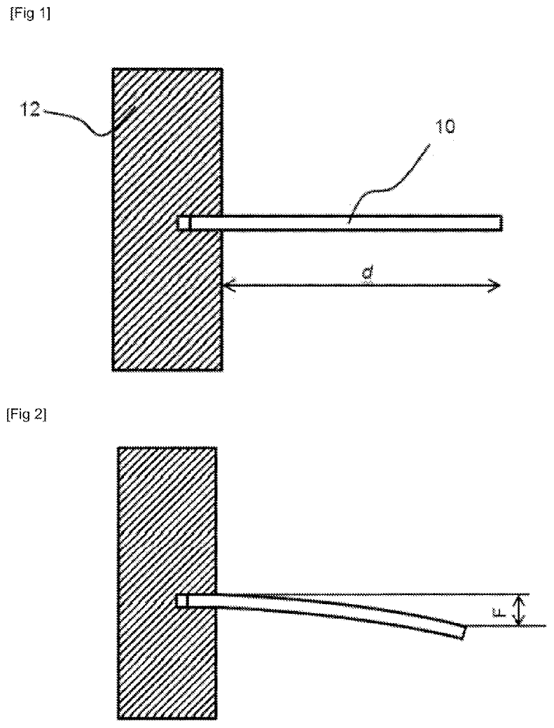

As shown in FIG. 1, one end of each bar 10 is subsequently inserted up to a length equal to 5 mm into an alumina support 12. Each bar therefore has an overhang length d equal to 70 mm. The bar-support assembly is subsequently placed on a metal grid, and the full set-up is then placed in a glass container, said glass container being arranged in a heating bath temperature controlled to ambient temperature. Isopropanol is subsequently introduced into the glass container so as to fully cover the bars. The glass container is subsequently closed. The isopropanol is subsequently brought to a temperature equal to 60° C. by virtue of the action of the temperature-controlled heating bath. This temperature is maintained for 24 hours, with care being taken to ensure that the isopropanol entirely covers the bars over the whole of this period. The temperature-controlled heating bath is subsequently switched off and the isopropanol is removed from the glass container when its temperature reaches 55° C. The glass container is subsequently opened, the bar-support assembly is recovered and subsequently dried for 24 hours at ambient temperature, with the bars remaining inserted in the support during this period.

The deformation of the bar is subsequently measured by the deflection F, as described in FIG. 2. A mean of the deformation of the 5 bars is produced for each molding composition tested.

Deformation after thermal debinding is measured as follows:

Bars are produced according to the same manufacturing protocol as described above for measuring deformation during debinding using a solvent. 5 bars are produced for each molding composition to be characterized.

The bars are then placed flat on an open metal grid, and the entire set-up is arranged in a glass container, said glass container being arranged in a heating bath temperature controlled to ambient temperature. Isopropanol is subsequently introduced into the glass container so as to fully cover the bars. The glass container is subsequently closed. The isopropanol is subsequently brought to a temperature equal to 60° C. by virtue of the action of the temperature-controlled heating bath. This temperature is maintained for 24 hours, with care being taken to ensure that the isopropanol entirely covers the bars over the whole of this period. The temperature-controlled heating bath is subsequently switched off and the isopropanol is removed from the glass container when its temperature reaches 55° C. The glass container is subsequently opened, the bars are recovered and subsequently dried for 24 hours at ambient temperature. This procedure makes it possible to obtain, after debinding using a solvent, bars which are not deformed.

As shown in FIG. 1, one end of each bar 10 is subsequently inserted up to a length equal to 15 mm into an alumina support 12. Each bar therefore has an overhang length d equal to 60 mm. The bar-support assembly is subsequently placed into an electric oven and subjected to the following thermal debinding cycle:
rise from ambient temperature to 150° C. at a rate equal to 30° C./h,
rise from 150° C. to 350° C., at a rate equal to 15° C./h,
hold at 350° C. for 3 hours,
rise from 350° C. to 550° C., at a rate equal to 9° C./h,
hold at 550° C. for 1 hour,
rise from 550° C. to 820° C., at a rate equal to 180° C./h,
rise from 820° C. to 1,000° C., at a rate equal to 150° C./h,
drop to ambient temperature.

The deformation of the bars after thermal debinding is subsequently measured by the deflection F, as described in FIG. 2. A mean of the deformation of the 5 bars is produced for each molding composition tested.

### Manufacturing Protocol

Bars of molding composition to be tested were produced using the method described for the manufacture of the bars required for measuring the deformation during debinding using a solvent and during thermal debinding.

The following products were used for the different binder compositions:
a polypropylene powder having a weight-average molar mass equal to 135,060 g/mol, said powder having a median size equal to 1 mm,
a high-density polyethylene powder having a weight-average molar mass equal to 38,000 g/mol, said powder having a median size equal to 1 mm,
a SEBS Kraton® A1535 H powder, sold by Kraton, having a content by weight of styrene equal to 56% and a weight-average molar mass equal to 236,350 g/mol,
a SEBS Kraton® G1650 E powder, sold by Kraton, having a content by weight of styrene equal to 30% and a weight-average molar mass equal to 80,230 g/mol,
a SEBS Kraton® G1657 V powder, sold by Kraton, having a content by weight of styrene equal to 13% and a weight-average molar mass equal to 110,610 g/mol,
a SEBS powder having a content by weight of styrene equal to 21% and a weight-average molar mass equal to 108,660 g/mol,
a paraffin wax powder having a weight-average molar mass equal to 577 g/mol, a melting point equal to 55° C., said powder having a median size equal to 1 mm,
an acrylic resin powder, Elvacite® 2045, sold by Lucite International, having a weight-average molar mass equal to 127,340 g/mol,
a stearic acid powder having a purity of greater than 98% by weight, sold by Sigma-Aldrich,
an antioxidant powder, Irganox 1010, sold by Sigma-Aldrich.

The compositions of the binders used in the examples, and also the characterizations performed on the molding compositions, are described in the following table 1, with the absolute density of the products of examples 1 to 9 being fixed at 6.095 g/cm³ after sintering, said sintering being performed on bars which have been subjected to debinding using a solvent and thermal debinding as described previously, followed by sintering in an electric oven according to the following thermal cycle:
rise from ambient temperature to 500° C. at a rate equal to 100° C./h,
hold at 500° C. for 2 hours,
rise from 500° C. to 1,450° C., at a rate equal to 100° C./h,
hold at 1,450° C. for 2 hours,
drop to ambient temperature.

TABLE 1

| Ex. | | Ex. | Ex. | | Ex. | | | |
|---|---|---|---|---|---|---|---|---|
| 1(*) | Ex. 2 | 3(*) | 4(*) | Ex. 5(*) | 6(*) | Ex. 7 | Ex. 8 | Ex. 9 |

Constituents of the binder in percentage by weight

| | | | | | | | | | | |
|---|---|---|---|---|---|---|---|---|---|---|
| Polymer | Polypropylene | 65 | 10.7 | 10.7 | 10.7 | 13.5 | 8.7 | 12.6 | 9.6 | 10.7 |
| base (a) | powder | | | | | | | | | |
| | Polyethylene | 0 | 25.0 | 25.0 | 25.0 | 31.6 | 20.4 | 29.5 | 22.5 | 25.0 |
| | powder | | | | | | | | | |
| | SEBS Kraton ® | 0 | 10.4 | 0 | 0 | 1 | 17 | 4 | 14 | 0 |
| | A1535 H | | | | | | | | | |
| | powder | | | | | | | | | |
| | SEBS Kraton | 0 | 0 | 10.4 | 0 | 0 | 0 | 0 | 0 | 0 |
| | G1650 E | | | | | | | | | |
| | powder | | | | | | | | | |
| | SEBS Kraton | 0 | 0 | 0 | 10.4 | 0 | 0 | 0 | 0 | 0 |
| | G1657V | | | | | | | | | |
| | powder | | | | | | | | | |
| | SEBS powder | 0 | 0 | 0 | 0 | 0 | 0 | 0 | 0 | 10.4 |
| | having a | | | | | | | | | |
| | styrene content | | | | | | | | | |
| | equal to 21% | | | | | | | | | |
| | and a weight- | | | | | | | | | |
| | average molar | | | | | | | | | |
| | mass equal to | | | | | | | | | |
| | 108,660 g/mol | | | | | | | | | |
| | Elvacite ® 2045 | 0 | 3.1 | 3.1 | 3.1 | 3.1 | 3.1 | 3.1 | 3.1 | 3.1 |
| | acrylic resin | | | | | | | | | |
| Wax (b) | Paraffin wax | 30 | 46.2 | 46.2 | 46.2 | 46.2 | 46.2 | 46.2 | 46.2 | 46.2 |
| Surfactant | Stearic acid | 5 | 3.5 | 3.5 | 3.5 | 3.5 | 3.5 | 3.5 | 3.5 | 3.5 |
| (c) | | | | | | | | | | |
| Other | Irganox 1010 | 0 | 1.1 | 1.1 | 1.1 | 1.1 | 1.1 | 1.1 | 1.1 | 1.1 |
| components | antioxidant | | | | | | | | | |
| (d) | | | | | | | | | | |

Characteristics of the molding composition after molding

| | | | | | | | | | |
|---|---|---|---|---|---|---|---|---|---|
| Deformation after debinding | 14.1 | 8.1 | 16.7 | 14.6 | 9.4 | 10 | 10.4 | 12 | 11.5 |
| using a solvent- | | | | | | | | | |
| measurement of deflection F | | | | | | | | | |
| (mm) | | | | | | | | | |
| Deformation after thermal | 6.1 | 7 | 13 | 8 | Broken | 7 | 7 | 7.5 | 8.1 |
| debinding-measurement of | | | | | bars | | | | |
| deflection F (mm) | | | | | | | | | |
| Apparent density after | 6.01 | 6.06 | 6.04 | 6.05 | n.d. | 6.00 | 6.06 | 6.07 | 6.07 |
| sintering (g/cm³) | | | | | | | | | |
| Relative density after | 98.61 | 99.43 | 99.10 | 99.26 | n.d. | 98.44 | 99.43 | 99.59 | 99.59 |
| sintering (%) | | | | | | | | | |

(*)example not in accordance with the invention;
n.d.: not determined

A comparison of comparative example 1 and example 2 according to the invention shows the critical impact, on deformation after debinding using a solvent and on the relative density after sintering, of the presence of a SEBS in the claimed amounts in the binder.

A comparison of example 2 according to the invention and comparative example 3 obtained with a binder comprising a SEBS having a weight-average molar mass lower than the subject matter of the invention shows the critical impact, on deformation after debinding using a solvent, on deformation after thermal debinding, and also on the relative density after sintering, of a SEBS having a weight-average molar mass of greater than 100,000 g/mol.

A comparison of example 2 according to the invention and comparative example 4 obtained with a binder comprising a SEBS having too low a styrene content in relation to the present invention shows the critical impact, on deformation after debinding using a solvent, of a SEBS having a content by weight of styrene of greater than 15%, in percentage by weight based on the weight of said SEBS.

A comparison of example 2 according to the invention and comparative example 5 obtained with a binder comprising too low an amount of SEBS in relation to the present invention shows the critical impact, on relative density after sintering, of a minimum content of 2% of SEBS in the binder: the relative density of example 5 was not determined because said example exhibited unacceptable cracking.

A comparison of example 2 according to the invention and comparative example 6 obtained with a binder comprising too great an amount of SEBS in relation to the present invention, shows the critical impact, on deformation after debinding using a solvent and on the relative density after sintering, of a maximum content of 15% SEBS in the binder.

Examples 7, 8 and 9 also illustrate the invention and the advantages thereof.

As is now clearly apparent, the invention makes it possible to limit the deformation of the preform in step C) while leading to a sintered part having a relatively high density.

Of course, the invention is not limited to the embodiments described, which are provided merely for illustrative purposes.

1. A binder for an injection molding composition, said binder consisting of, in percentage by weight and for a total of 100%:
35% to 60% of a component (a), or polymer base, consisting of a polymer or a mixture of polymers, each said polymer being non-amphiphilic and having a weight-average molar mass of greater than or equal to 5,000 g/mol,
30% to 55% of a component (b), or wax, consisting of a polymer or a mixture of polymers, each said polymer being non-amphiphilic and having a weight-average molar mass of less than or equal to 5,000 g/mol, and
less than 10% of an amphiphilic component (c), or surfactant, and
less than 10% of other components (d),
the polymer base comprising 2% to 15% of a styrene-ethylene-butylene-styrene copolymer (SEBS), in percentage by weight based on the weight of the binder, the content by weight of styrene in the SEBS being greater than 15% in percentage by weight based on the weight of said SEBS, a weight-average molar mass of said SEBS being greater than 100,000 g/mol.

2. The binder according to claim 1, wherein the content of SEBS is greater than or equal to 4% and less than or equal to 13% in percentage by weight based on the weight of the binder.

3. The binder according to claim 1, wherein the content of styrene in the SEBS is greater than 20% and less than 60% in percentage by weight based on the weight of said SEBS.

4. The binder according to claim 3, wherein the content of styrene in the SEBS is greater than 25% in percentage by weight based on the weight of said SEBS.

5. The binder according to claim 1, wherein the weight-average molar mass of the SEBS is greater than 160,000 g/mol and less than 400,000 g/mol.

6. The binder according to claim 1, wherein the amount of surfactant is greater than or equal to 0.5%.

7. The binder according to claim 1, having, in percentage by weight based on the binder:
an amount of polymer base of greater than or equal to 40% and less than or equal to 55%, and
an amount of wax of greater than or equal to 35% and less than or equal to 53%, and
an amount of surfactant of greater than or equal to 1% and less than or equal to 8%, and
an amount of other components of greater than or equal to 0.5% and less than or equal to 8%.

8. The binder according to claim 7, having, in percentage by weight based on the binder:
an amount of polymer base of greater than or equal to 45% and less than or equal to 50%, and
an amount of wax of greater than or equal to 40% and less than or equal to 50%, and
an amount of surfactant of greater than or equal to 2% and less than or equal to 6%, and
an amount of other components of greater than or equal to 1% and less than or equal to 4%.

9. The binder according to claim 1, having at least one of the following characteristics:
each constituent of the polymer base has a weight-average molar mass of greater than 20,000 g/mol,
a constituent of the wax, preferably each constituent of the wax, has a weight-average molar mass of greater than 400 g/mol and less than 3,000 g/mol,
each constituent of the surfactant has a weight-average molar mass of less than 800 g/mol.

10. The binder according to claim 9, having at least one of the following characteristics:
each constituent of the polymer base has a weight-average molar mass of greater than 30,000 g/mol,
a constituent of the wax, preferably each constituent of the wax, has a weight-average molar mass of less than 1,500 g/mol,
each constituent of the surfactant has a weight-average molar mass of less than 500 g/mol.

11. The binder according to claim 1, having at least one of the following characteristics:
the polymer base comprises a polymer selected from the group consisting of polypropylenes, polyethylenes, ethylene-vinyl acetates, ethylene-ethyl acrylates, polystyrenes, polyethylene carbonates, diethyl phthalate, dioctyl phthalate, dibutyl phthalate, polyvinyl alcohol, polyvinyl acetate, ethylene-methacrylic acid copolymers, polyvinyl chloride, polyvinyl butyral, a polyacetal, a polymethyl methacrylate, a polybutyl methacrylate, a methacrylic acid ester copolymer, a methyl ethyl ketone, resins, and mixtures thereof,
the wax comprises, or consists of, a wax selected from the group consisting of carnauba wax, a paraffin wax, a beeswax, a polyethylene wax, a microcrystalline wax, a vegetable oil, a groundnut oil, a mineral oil, glycerol and mixtures thereof,
the surfactant comprises, or consists of, an amphiphilic constituent selected from the group consisting of an ethylene bis(stearamide), stearin, palmitic acid, butyl stearate, boric acid, oleic acid, lauric acid, stearic acid and mixtures thereof.

12. The binder according to claim 1, having at least one of the following characteristics:
the polymer base comprises a mixture of polypropylene and of polyethylene in a polypropylene/polyethylene weight ratio of greater than 25/75 and less than 50/50.
the surfactant consists of an amphiphilic constituent selected from an ethylene bis(stearamide), stearic acid and mixtures thereof.

13. An injection molding composition comprising between 30% and 65% of a binder according to claim 1, in a percentage by volume based on the volume of the molding composition, the remainder being, for more than 90% by weight, a ceramic powder.

14. The molding composition according to claim 13, having at least one of the following characteristics:
the amount of binder is greater than or equal to 45% and less than or equal to 55%, in percentage by volume based on the volume of the molding composition,
the ceramic powder comprises more than 90% by weight of nitride(s) and/or carbide(s) and/or oxide(s).

15. The molding composition according to claim 14, wherein said oxides are selected from the group consisting of ZrO₂, Y₂O₃, CeO₂, CaO, MgO, manganese oxides, ZnO, praseodymium oxides, copper oxides, BaO, iron oxides, Sc₂O₃, TiO₂, Al₂O₃, La₂O₃, Nd₂O₃, Yb₂O₃, and mixtures thereof.

16. A method for manufacturing a sintered part, said method comprising:
A) producing a molding composition,
B) injection molding said molding composition in order to obtain a preform,
C) at least partially debinding the preform,
D) sintering the at least partially debound preform in order to obtain a sintered part, the molding composition being in accordance with claim 13.

17. The binder according to claim 7, wherein the other components are a stabilizer.

18. The binder according to claim 8, wherein the other components are a stabilizer.

19. The binder according to claim 11, wherein the wax is a paraffin wax.
